(19) United States
(12) Patent Application Publication
(10) Pub. No.: US 2012/0184262 A1
(43) Pub. Date: Jul. 19, 2012

(54) HLR Reset Signaling via S6A in EPS

(75) Inventors: Lars-Bertil OLSSON, Angered (SE); Peter Ramle, Molnlycke (SE); Yong Yang, Molndal (SE)

(73) Assignee: Telefonaktiebolaget L M Ericsson (publ), Stockholm (SE)

(21) Appl. No.: 13/349,985

(22) Filed: Jan. 13, 2012

Related U.S. Application Data
(63) Continuation of application No. PCT/EP2012/050441, filed on Jan. 12, 2012.
(60) Provisional application No. 61/432,654, filed on Jan. 14, 2011.

(51) Int. Cl. H04W 8/02

(52) U.S. Cl. 455/422.1

(57) ABSTRACT

Embodiments relate to HLR reset signalling via the s6a interface in EPS. This is provided as nodes and methods for improved utilization of radio resources in a telecommunications network, where Home location registers (HLR) identities related to associated user equipment contexts and associated Mobile Service Centers (MSC) are saved in a mobility management entity (MME). An identity of a restarted HLR is received in the MME and the MME compares the HLR identity with a saved list of HLR identities saved for UE and associated with a respective mobile service center (MSC) server. The MME sets a flag for UE associated with the restarted HLR, the flag indicating an alert. When the MME receives a UE signaling event for a UE with the flag set the MME sends an SGs application Part message to the respective MSC server to indicate that activity from the UE has been detected.

This application claims the benefit of U.S. Provisional Patent Application No. 61/432,654, filed on Jan. 14, 2011, the entire contents of which is incorporated by reference herein; this application is a continuation of International Patent Application No. PCT/EP2012/050441, filed Jan. 12, 2012, the entire contents of which is incorporated by reference herein.

### TECHNICAL FIELD

Embodiments herein relate generally to improved utilization of radio resources and HLR reset signalling via the s6a interface in the Evolved Packet System (EPS) in particular.

### BACKGROUND

In a typical cellular system, also referred to as a wireless communications network, communication network, network or system, wireless terminals, also known as mobile stations and/or User Equipment units (UEs) communicate via Radio Access Networks (RAN) to a core network (CN). The network covers a geographical area which is divided into cell areas, with each cell area being served by a base station, e.g. a Radio Base Station (RBS), which in some networks is also called eNodeB (eNB), NodeB, B node or base station. The base stations communicate over the air interface operating on radio frequencies with the user equipments within range of the base stations.

A user equipment may be any suitable communication device or computational device with communication capabilities capable to communicate with a base station over a radio channel, for instance but not limited to mobile phone, smart phone, personal digital assistant (PDA), laptop, MP3 player or portable DVD player (or similar media content devices), digital camera, or even stationary devices such as a PC. A PC may also be connected via a mobile station as the end station of the broadcasted/multicasted media. The user equipment may also be an embedded communication device in e.g. electronic photo frames, cardiac surveillance equipment, intrusion or other surveillance equipment, weather data monitoring systems, vehicle, car or transport communication equipment, etc. The user equipment is referred to as UE in some of the figures.

A communication network ties a number of computers, terminals and wireless devices together for exchange of information. These computers, terminals and wireless devices are also called nodes of the network.

It should be noted that the communication link between the base station and the network may be of any suitable kind comprising either a wired or wireless link. The link may use any suitable protocol depending on type and level of layer, e.g. as indicated by the Open Systems Interconnection (OSI) model, as understood by the person skilled in the art.

Evolved Packet System (EPS) is a communication network developed within 3GPP, and which comprises a radio access system and a core network. The radio network is referred to as evolved UMTS terrestrial radio access network (E-UTRAN) and the packet switched core network is referred to as evolved packet core (EPC).

A UE 101 may start to interact with an evolved packet core (EPC) enabled network by executing an E-UTRAN Attach procedure. In E-UTRAN the attach procedure comprises setup of a packet data network (PDN) connection which results in an activated default bearer.

Long Term Evolution (LTE) technology supports packet based services only; however 3GPP specifies fallback for circuit switched (CS) services as well. In LTE, the circuit switched fallback in EPS enables the provisioning of voice and traditional CS-domain services. To provide these services LTE reuses CS infrastructure when the UE 101 is served by E-UTRAN 103. A CS fallback enabled terminal, connected to E-UTRAN 103 may use GERAN 123 or UTRAN 125 to connect to the CS domain. FIG. 2 illustrates embodiments of an EPS architecture 200 for CS fallback and Short Message Service (SMS) over an SGs interface. The SGs interface is the reference point between the MME 105 and Mobile Service Centre (MSC) server 227. The SGs interface is used for the mobility management and paging procedures between EPS and CS domain, and is based on the Gs interface procedures.

As part of the attach procedure the MME 105 may perform location updating of the UE 101 towards the MSC Server 227.

A location updating by the MSC Server 227 registers the UE 101 at a Home Location Register (HLR) 230. The registration at the HLR 230 makes it possible for the network to reach the UE 101 for mobile terminating SMS and/or mobile terminating voice calls.

Recovery after HLR restart in legacy GERAN or UTRAN will be discussed below:

An HLR 230 that is restarted does no longer know which UEs 101 that previously were registered and to enable use of mobile terminating SMS and/or mobile terminating voice call the UEs 101 must once again become registered. Until the UE 101 has been re-registered the UE 101 is unreachable for mobile terminating services.

MSC Server 227 and SGSN 120 become aware of an HLR restart when respective node receives the HLR reset indication sent by the HLR 230 after it has been restarted.

In use of legacy combined procedures the HLR 230 is directly connected also to the SGSN 120. When the SGSN 120 receives an HLR reset indication the SGSN 120 set the internal flag Non-GPRS Alert Flag (NGAF) for each impacted UE 101. At next UE 101 signaling event for a UE 101 where the flag NGAF is set, the SGSN 120 sends a Base Station System Application Part (BSSAP)+-ACTIVITY-INDICATION message to the MSC Server 227.

Recovery after HSS restart in EPS will now be discussed below.

An HSS 108 that is restarted does no longer know which UEs 101 that previously were registered and to enable use of mobile terminating SMS and/or mobile terminating voice call the UEs 101 must once again become registered. Until the UE 101 has been re-registered the UE 101 is unreachable for mobile terminating services.

MME 105 becomes aware of an HSS restart when it receives an HSS reset indication sent by the HSS 108 after it has restarted.

With use of combined procedures in EPS, an MME 105 that receives an HSS reset indication will cause the MME 105 to set a node internal flag NEAF for each impacted UE 101. At next UE signaling event for a UE 101 where the NEAF is set, the MME 105 sends a SGsAP-UE-ACTIVITY-INDICATION to the MSC Server 227. This is used to trigger the MSC Server 227 to perform a location update towards the HLR 230 in order to restore the HLR data.

Recovery after HLR restart in EPS will now be discussed below.

An HLR 230 that is restarted does no longer know which UEs 101 that previously were registered and to enable use of mobile terminating SMS and/or mobile terminating voice call the UEs 101 must once again become registered. Until the UE 101 has been re-registered the UE 101 is unreachable for mobile terminating services.

MSC Server 227 becomes aware of an HLR restart when it receives an HLR reset indication sent by the HLR 230 after it has restarted.

The MME 105 is not connected to the HLR 230 and does not become aware of an HLR restart.

With use of combined procedures in EPS, an MSC Server 227 that receives an HLR reset indication may signal the message SGsAP-RESET-INDICATION to trigger the MME 105 to set an internal flag VLR Reliable=False for each impacted UE 101. At next UE signaling event for a UE 101 where VLR Reliable=False, the MME 105 performs a location update, possibly preceded by an IMSI-detach to trigger the UE 101 to perform the combined RAU procedure, with IMSI attach.

By sending the message SGsAP-RESET-INDICATION, the MSC Server 227 request the MME 105 to restore all UE associations regardless if only a fraction of the UEs 101 registered at the MSC Server 227 at the time of an HLR restart were impacted. This results in unnecessary signaling.

As an alternative an MSC Server 227 that receives an HLR reset indication may signal the message SGsAP-ALERT-REQUEST, one for each and every impacted UE 101, to trigger the MME 105 to set an internal flag, non-EPS alert flag, NEAF for each impacted UE 105. At next UE signaling event for a UE 101 where the NEAF is set, the MME 105 sends an SGsAP-UE-ACTIVITY-INDICATION to the MSC Server 227. This is used to trigger the MSC Server 227 to perform a location update towards the HLR 230 in order to restore the HLR data. The sending of SGsAP-ALERT-REQUEST for each and every impacted UE 101 causes a massive signaling load.

### SUMMARY

The objective of embodiments herein is therefore to obviate at least one of the above disadvantages and to provide improved utilization of radio resources in a communication network.

This is provided in a number of aspects in which a first is a mobility management entity, MME, in a telecommunications network. The MME comprises a processing unit, a receiving unit, a transmitting unit, and a memory unit. The processing unit is arranged to execute instruction sets stored in the memory unit for receiving on the receiving unit a message comprising an identity of a restarted home location register, HLR, comparing the HLR identity with an in the memory unit saved list of HLR identities saved for user equipment, UE, and associated with a respective mobile service center, MSC, server, Setting a flag for user equipment associated with the restarted HLR, the flag indicating an alert, receiving a UE signaling event for a UE with the flag set, and sending in the transmitting unit an SGs application Part message to the respective MSC server to indicate that activity from the UE has been detected. The flag may be for instance a non-EPS alert flag, NEAF.

The received message may be received in relation to an HLR reset indication. The transmitting of the HRL identity may be performed over an S6a interface.

The processing unit of the MME may further be arranged to send an update location request to a Home subscriber server, HSS, receive a HLR identity from the HSS, and save the HLR identity as part of a UE context.

Another aspect of the present invention is provided, a method for providing improved utilization of radio resources in a telecommunications network. The method may comprise steps of receiving on the receiving unit a message comprising an identity of a restarted home location register, HLR, comparing the HLR identity with an in a memory unit saved list of HLR identities saved for user equipment, UE, and associated with a respective mobile service center, MSC, server, Setting a flag for user equipment associated with the restarted HLR, the flag indicating an alert, receiving a UE signaling event for a UE with the flag set, and sending in a transmitting unit an SGs application Part message to the respective MSC server to indicate that activity from the UE has been detected.

Yet another aspect of the present invention is provided, a Home Subscriber Server, HSS, in a telecommunications network. The HSS may comprise a processing unit, a receiving unit, and a transmitting unit. The processing unit may be arranged to execute instruction sets to receive on the receiving unit a message comprising an indication of an Home Location Register, HLR, reset, and send using the transmitting unit one indication to each impacted mobility management entity, MME, wherein the message comprises an identity of the HLR.

The processing unit of the HSS is further arranged to in response to an update location request from an MME provide an HLR identity. The HLR identity may be a mobile subscriber identity, IMSI, associated with a user equipment, UE.

Furthermore, another aspect of the present invention is provided, a method in a Home subscriber server, HSS, in a telecommunications network. The method may comprise steps of receiving with a receiving unit a message comprising an indication of an Home Location Register, HLR, reset, and sending using a transmitting unit one indication to each mobility management entity, MME, wherein the message comprises an identity of the HLR.

Embodiments herein afford many advantages, for which a non-exhaustive list of examples follows:

The embodiments herein provide an advantage of substantially lowered signaling at an HLR restart. There will be only one message from the HSS to each MME where impacted UEs are registered instead of one message per impacted UE. The internal handling in the MME from a received HLR Reset with an HLR identity would be almost the same as the MME handling of a received HSS Reset, hence a low implementation impact to the MME.

The embodiments herein are not limited to the features and advantages mentioned above. A person skilled in the art will recognize additional features and advantages upon reading the following detailed description.

### BRIEF DESCRIPTION OF THE DRAWINGS

The embodiments will now be further described in more detail in the following detailed description by reference to the appended drawings in which:

FIG. 1 is a block diagram illustrating embodiments of a communication network.

FIG. 2 is a block diagram illustrating embodiments of an EPS architecture for CS fallback and SMS over SGs.

FIG. 3 is a combined signaling diagram and flowchart illustrating embodiments of a method in a communication network.

FIG. 4 is a combined signaling diagram and flowchart illustrating embodiments of a method in a communication network.

FIG. 5 is a block diagram illustrating embodiments of a first network node.

FIG. 6 is a block diagram illustrating embodiments of a second network node.

The drawings are not necessarily to scale and the dimensions of certain features may have been exaggerated for the sake of clarity, emphasize is instead being placed upon illustrating the principle of the embodiments herein.

### DETAILED DESCRIPTION

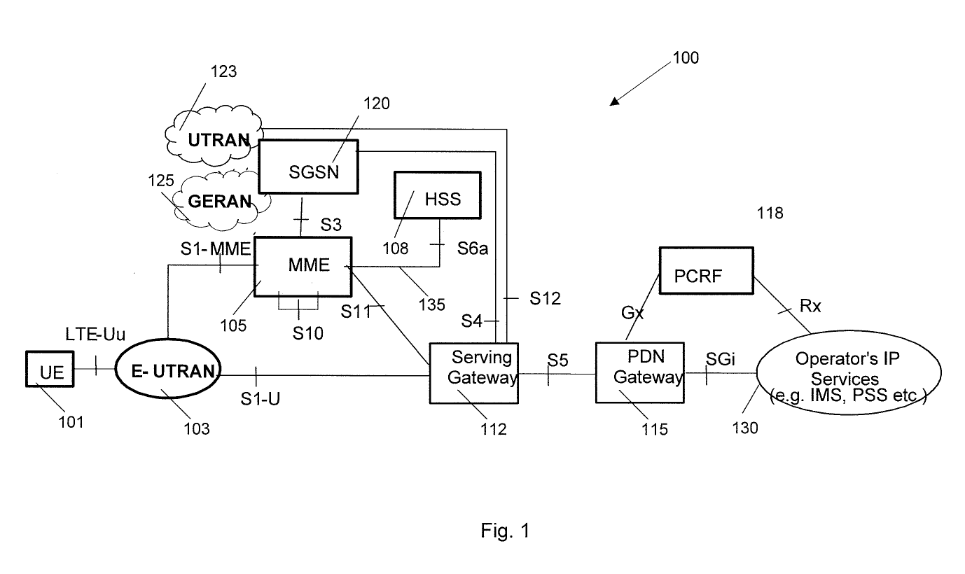

FIG. 1 depicts an embodiment of a communication network 100 illustrating a non-roaming architecture for the EPS. The network 100 comprises network nodes. Some of the network nodes comprised in the network 100 will be described below.

A User Equipment (UE) 101 may interact with the EPS using an E-UTRAN 103 radio access via an LTE-Uu interface. UE-related control signaling is handled by a Mobility Management Entity (MME) 105 connected to the E-UTRAN and with support of subscription information provided by a Home Subscriber Server (HSS) 108 connected to the MME via an S6a interface 135. User payload is handled by a Serving Gateway (S-GW) 112 and a PDN Gateway (P-GW) 115. The S-GW is connected to the E-UTRAN and the MME via S1-U and S11 interfaces respectively. The P-GW is connected to the S-GW via an S5 interface and may interact with a Policy and Charging Rules Function (PCRF) 118 via a Gx interface. A Serving GPRS Support Node (SGSN) 120 handles all packet switched data within the network 100 and may be connected to the MME and S-GW via S3 and S12 interfaces respectively. The SGSN 120 provides connections for GERAN 123 and UTRAN 125 networks. Furthermore, the PDN gateway and PCRF may be connected to an Operators IP Services 130, such as for instance IP Multimedia Subsystem (IMS), Transparent end-to-end Packet-switched Streaming Service (PSS), and so on via SGi and Rx interfaces respectively.

A UE 101 may start to interact with an evolved packet core (EPC) enabled network by executing an E-UTRAN Attach procedure. In E-UTRAN the attach procedure comprises setup of a packet data network (PDN) connection which results in an activated default bearer.

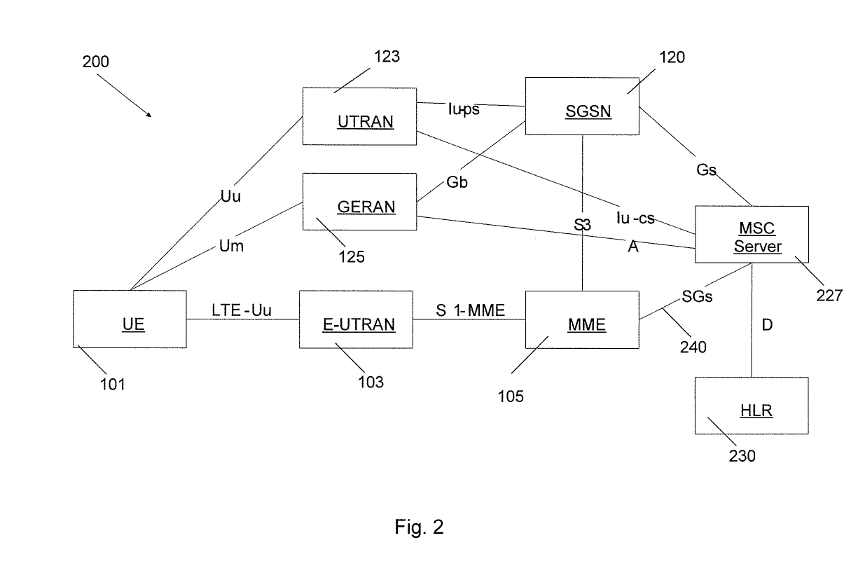

Long Term Evolution (LTE) technology supports packet based services only, however 3GPP specifies fallback for circuit switched (CS) services as well. In LTE, the circuit switched fallback in EPS enables the provisioning of voice and traditional CS-domain services. To provide these services LTE reuses CS infrastructure when the UE 101 is served by E-UTRAN 103. A CS fallback enabled terminal, connected to E-UTRAN 103 may use GERAN 123 or UTRAN 125 to connect to the CS domain. FIG. 2 illustrates embodiments of an Evolved Packet Service (EPS) architecture 200 for CS fallback and Short Message Service (SMS) over an SGs interface 240. The SGs interface is the reference point between the MME 105 and a Mobile Service Centre (MSC) server 227. The SGs interface is used for the mobility management and paging procedures between EPS and CS domain, and is based on the Gs interface procedures.

As part of the attach procedure the MME 105 may perform location updating of the UE 101 towards the MSC Server 227.

A location updating by the MSC Server 227 registers the UE 101 at a Home Location Register (HLR) 230. The registration at the HLR 230 makes it possible for the network to reach the UE 101 for mobile terminating SMS and/or mobile terminating voice calls.

In order to make a mobile terminated call, the network 100 should know the location of the user equipment 101 despite of its movement. For this purpose the user equipment 101 periodically reports its location to the network 100 using the Location Update procedure.

The location update procedure allows the user equipment 101 inform the network 100, whenever it moves from one location area to the next. The user equipments 101 are responsible for detecting location area codes. When a user equipment 101 finds that the location area code is different from its last update, it performs another update by sending to the network 100, a location update request, together with its previous location, and its Temporary Mobile Subscriber Identity (TMSI).

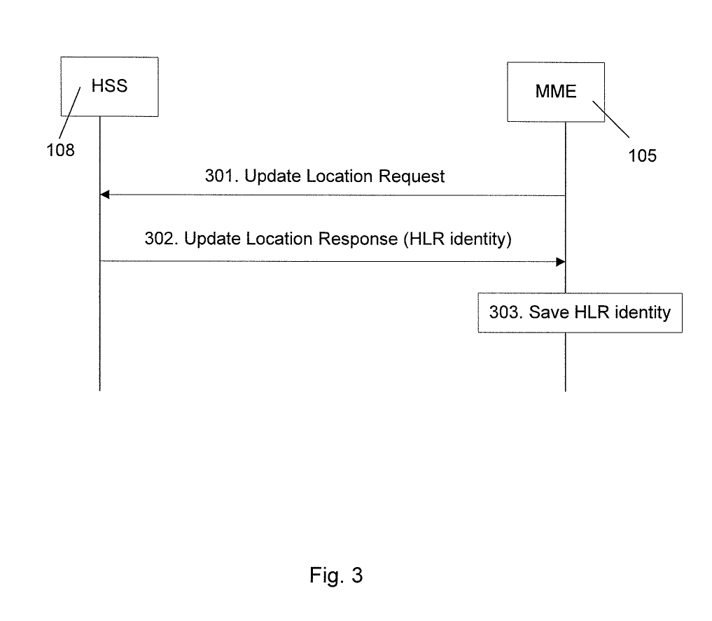

An embodiment for provide improved utilization of radio resources in a communication network will now be described with reference to the combined signaling diagram and flow chart depicted in FIG. 3. The method comprises the following steps, which steps may as well be carried out in another suitable order than described below.

Step 301: The MME 105 transmits an Update Location Request to the HSS 108.

The Location Update procedure may be performed when the user equipment 101 has been switched off and wants to become active, or when it is active but not involved in a call, and it moves from one location area to another, or after a regular time interval.

Step 302: In the response to an Update Location Request, the HSS 108 provides the MME 105 with the HLR identity. The HLR identity may be for example the International Mobile Subscriber Identity (IMSI) associated with the user equipment 101. The HSS 108 may e.g. get to know the serving HLR through local configuration based on IMSI.

Step 303: The MME 105 saves the HLR identity as part of the UE context. The HLR identity may be saved in an e.g. memory unit comprised in the MME 105.

By saving the HLR identity in the memory of the MME this may be used in further operation for improving utilization of radio resources as will be discussed below.

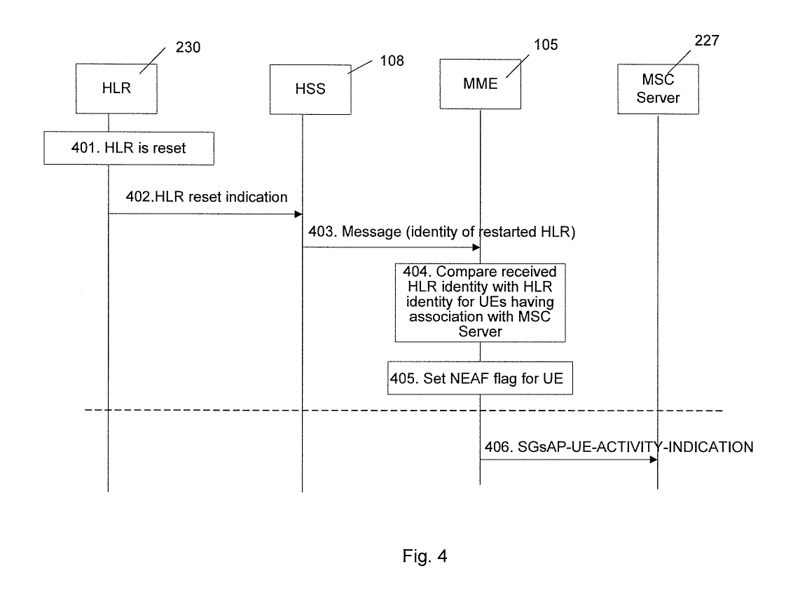

Another embodiment for providing improved utilization of radio resources in a communication network will now be described with reference to the combined signaling diagram and flowchart depicted in FIG. 4. The method comprises the following steps, which steps may as well be carried out in another suitable order than described below.

Step 401: The HLR 230 is reset. For example due to a restart or reset of the HLR.

Step 402: The HLR 230 transmits an HLR reset indication to the HSS 108.

Step 403: When the HSS has received the HLR reset indication from the HLR, the HSS sends only one message each to each impacted MMEs 105 via the S6a interface and where the message comprises the identity of the restarted/reset HLR 230.

The HLR identity may be for example the International Mobile Subscriber Identity (IMSI) associated with the user equipment 101.

Step 403: The MME 105 compares the received HLR identity with the HLR identity saved for the UEs 101 that have an association with an MSC Server 227.

Step 404: For each match in the comparing in step 403, the MME 105 sets an internal alert flag, e.g. a non-EPS alert flag (NEAF) for the UE 101.

Step 404: At the next UE signaling event for a UE 101 where the NEAF is set, the MME sends an SGs Application Part (SGsAP)-UE-ACTIVITY-INDICATION to the associated MSC Server 227.

The SGsAP-UE-ACTIVITY-INDICATION is a message that is sent by the MME to indicate that activity from a UE 101 has been detected. The message may comprise the IMSI associated with the detected UE 101. Reset signaling is provided over an S6a interface 135 between the MME and the HSS.

With use of combined procedures in EPS, an MSC Server 227 that receives an HLR reset indication may signal the message SGsAP-RESET-INDICATION to trigger the MME 105 to set an internal flag VLR Reliable=False for each impacted UE 101. At next UE signaling event for a UE 101 where VLR Reliable=False, the MME 105 performs a location update, possibly preceded by an IMSI-detach to trigger the UE 101 to perform the combined RAU procedure, with IMSI attach.

As an alternative an MSC Server 227 that receives an HLR reset indication may signal the message SGsAP-ALERT-REQUEST, one for each and every impacted UE 101, to trigger the MME 105 to set an internal flag, non-EPS alert flag, NEAF for each impacted UE 105. At next UE signaling event for a UE 101 where the NEAF is set, the MME 105 sends an SGsAP-UE-ACTIVITY-INDICATION to impacted and associated MSC Server 227.

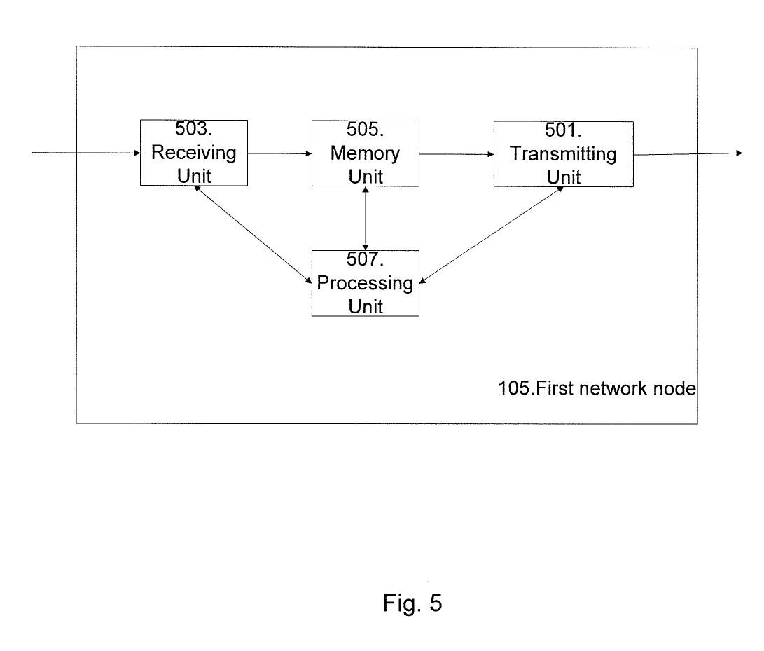

To perform the method steps shown in FIGS. 3 and 4 a first network node, such as e.g. the MME 105, comprises an arrangement as shown in FIG. 5. The first network node comprises a transmitting unit 501 configured to transmit a message to the second network node, e.g. the HSS 108. The message may be an Update Location Request.

In some embodiments, the transmitting unit 501 is further configured to send an SGs Application Part (SGsAP)-UE-ACTIVITY-INDICATION to the MSC Server 227. The SGsAP-UE-ACTIVITY-INDICATION is a message that is sent by the MME to indicate that activity from a UE 101 has been detected. The message may comprise the IMSI of the detected UE 101.

The first network node further comprises a receiving unit 503 configured to receive a reply message from the second network node. The message may comprise an HLR identity. The first network node further comprises a memory unit 505 configured to store the received HLR identity. The first network node further comprises a processing unit 507 configured to compare a received HLR identity with the HLR identity saved for the UEs 101 that have an association with an MSC Server 227. The processing unit 507 is further configured to, for each match in the comparing, to set a flag NEAF for each UE 101 with saved HLR identity and associated with an MSC server.

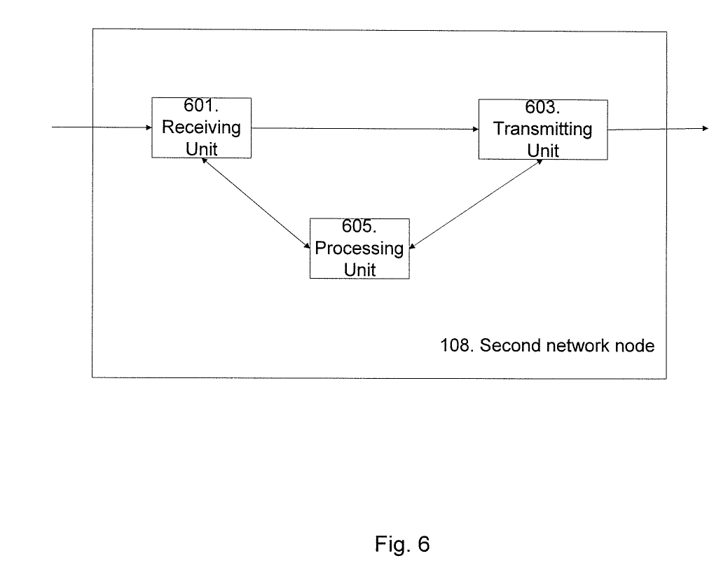

To perform the method steps shown in FIGS. 3 and 4 a second network node, such as e.g. the HSS 108, comprises an arrangement as shown in FIG. 6. The second network node comprises a receiving unit 601 configured to receive a message from the first network node, e.g. the MME. The message may be an Update Location Request. The receiving unit 601 may be further configured to receive an HLR reset indication from the HLR 230. The second network node may further comprise a transmitting unit 603 configured to transmit a message to the impacted MMEs 105 where the message comprises the identity of the restarted/reset HLR 230. The HLR identity may be for example the International Mobile Subscriber Identity (IMSI) associated with the user equipment 101.

The embodiments herein may be implemented through one or more processors, such as a processing unit 507 in the first network node depicted in FIG. 5 and a processing unit 605 in the second network node depicted in FIG. 6, together with computer program code for performing the functions of the embodiments herein. The processor may be for example a Digital Signal Processor (DSP), Application Specific Integrated Circuit (ASIC) processor, Field-programmable gate array (FPGA) processor or micro processor. The program code mentioned above may also be provided as a computer program product, for instance in the form of a data carrier carrying computer program code for performing the embodiments herein when being loaded into the first network node and/or second network node. One such carrier may be in the form of a CD ROM disc. It is however feasible with other data carriers such as a memory stick. The computer program code may furthermore be provided as pure program code on a server and downloaded to the first network node and/or second network node remotely.

The embodiments are not limited to the above described embodiments. Various alternatives, modifications and equivalents may be used. Therefore, the above embodiments should not be taken as limiting the scope of the embodiments.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasized that the steps of the method may, without departing from the embodiments herein, be performed in another order than the order in which they appear.

1. A mobility management entity, MME, in a telecommunications network, comprising:
a processing unit;
a receiving unit;
a transmitting unit; and
a memory unit;
wherein the processing unit is arranged to execute instruction sets stored in the memory unit for:
receiving on the receiving unit a message comprising an identity of a restarted home location register, HLR;
comparing the HLR identity with an in the memory unit saved list of HLR identities saved for user equipment, UE, and associated with a respective mobile service center, MSC, server;
setting a flag for user equipment associated with the restarted HLR, the flag indicating an alert;
receiving a UE signaling event for a UE with the flag set; and
sending in the transmitting unit an SGs application Part message to the respective MSC server to indicate that activity from the UE has been detected.

2. The MME according to claim 1, wherein the received message is received in relation to an HLR reset/restart indication.

3. The MME according to claim 1, wherein the transmitting of the HRL identity is performed over an S6a interface.

4. The MME according to claim 1, wherein the processing unit is further arranged to send an update location request to a Home subscriber server, HSS, receive a HLR identity from the HSS, and save the HLR identity as part of a UE context.

5. The MME according to claim 4, wherein the HLR identity is received from the HSS in relation to an update location request.

6. The MME according to claim 1, wherein the flag is one of a non-EPS alert flag, NEAF, or Visiting location register, VLR, Reliable set to False.

7. A method for providing improved utilization of radio resources in a telecommunications network comprising steps of:
receiving a message comprising an identity of a restarted home location register, HLR;
comparing the HLR identity with an in a memory unit saved list of HLR identities saved for user equipment, UE, and associated with a respective mobile service center, MSC, server;
setting a flag for user equipment associated with the restarted HLR, the flag indicating an alert;
receiving a UE signaling event for a UE with the flag set; and
sending an SGs application Part message to the respective MSC server to indicate that activity from the UE has been detected.

8. The method according to claim 7, further comprising steps of sending an update location request to a Home Subscriber Server, HSS, receiving a HLR identity from the HSS, and saving the HLR identity as part of a UE context.

9. The method according to claim 7, wherein the flag is one of a non-EPS alert flag, NEAF, or Visiting location register, VLR, Reliable set to False.

10. A home subscriber server, HSS, in a telecommunications network, comprising
a processing unit;
a receiving unit; and
a transmitting unit;
wherein the processing unit is arranged to execute instruction sets to:
receive on the receiving unit a message comprising an indication of an Home Location Register, HLR, reset; and
send using the transmitting unit one indication to each impacted mobility management entity, MME, wherein the message comprises an identity of the HLR.

11. The HSS according to claim 10, wherein the processing unit is further arranged to in response to an update location request from an MME provide an HLR identity.

12. The HSS according to claim 10, wherein the HLR identity is a mobile subscriber identity, IMSI, associated with a user equipment, UE.

13. A method in a home subscriber server, HSS, in a telecommunications network, the method comprising steps of
receiving a message comprising an indication of an Home Location Register, HLR, reset; and
sending one indication to each mobility management entity, MME, wherein the message comprises an identity of the HLR.

14. The method according to claim 13, further comprising steps of receiving an update location request from an MME and in response providing an HLR identity.
